(19) United States
(12) Patent Application Publication
(10) Pub. No.: US 2005/0162667 A1
(43) Pub. Date: Jul. 28, 2005

(54) System and method for de-spooler job joining

(76) Inventors: Leonard Felix, Camas, WA (US); Andrew Rodney Ferlitsch, Tigard, OR (US); Carl Victor Staub, Vancouver, WA (US)

Correspondence Address: Gerald W. Maliszewski, P.O. Box 270829, San Diego, CA, 92198-2829, US

(21) Appl. No.: 10/763,700

(22) Filed: Jan. 23, 2004

(51) Int. Cl. G06F 15/00

(52) U.S. Cl. 358/1.1; 358/1.13

(57) ABSTRACT

A system and method are provided for de-spooler job joining. The method comprises: despooling a plurality of print jobs at a client device; joining the print jobs into a single joined print job; and, rendering the joined print job as a single continuous print job. The de-spooler may be part of an imaging device or the client device supplying the print jobs. In one aspect, joining the print jobs includes: concatenating; creating a single spool file with multiple raster image processes (RIPs). Alternately, joining the print jobs includes: generating a RIP for each print job, with RIP end/start instructions; removing the RIP end/start instructions; concatenating the plurality of RIPs; and, creating a single spool file with a single RIP. In another aspect, joining the print jobs includes: converting each print job into an image format file; and, merging into a single RIP.

### BACKGROUND OF THE INVENTION

1. Field of the Invention

This invention generally relates to digital document processing and, more particularly, to a system and method for joining a plurality of print jobs into a single continuous print job, to maximize printer efficiencies.

2. Description of the Related Art

Conventional multifunctional peripherals (MFPs) increasingly having the ability to process multiple page and/or multiple copies at high speeds. More specifically, these devices tend to be able to print the second page of a job, and/or a second copy at the rated engine speed. One problem that still exists with these machines, however, is the ability to obtain maximum engine performance when printing a continuous stream of single-copy single-page, or otherwise low page count jobs. Few machines have implemented an effective method of job streaming or job streaming low page count jobs.

FIG. 1 is a schematic block diagram illustrating an MFP that implements a single job pipelining method (prior art). Conventionally, network imaging printing devices using peer-to-peer printing protocols, for example line printer remote (LPR) or Internet printing protocol (IPP), and conventional host-side print generation and spooling/de-spooling subsystems, for example the graphics device interface (GDI) Microsoft Windows®, process jobs using a serial job processing method, such as non-job streaming. In this method, the host-side print spooler only sends a single job to the device at any time. The spooler then waits on sending the next job to the printer, when multiple jobs are queued up, until the printer acknowledges that the job has been completed. For example, when despooling a print job from Microsoft Windows® family of operating systems, such as 98, Me, NT, 2000, XP, or 2003 Server for example, using the LPR or IPP protocol to a conventional laser printer, the spooler waits on despooling the next job until a notification has been received that the first job has completed rasterization (RIP). This delay between the receipt and processing of a first and a second job, referred to as inter-job network and inter-RIP delay, can be significant. This delay may cause the printer to perform at substantially below its rated engine speed, as it processes a continuous stream of small jobs. The Sharp AR-275N is an example of an MFP which implements the LPR and IPP protocols for single job pipelining.

FIG. 2 is a diagram showing a MFP with multiple job pipelining capability, using a hard-drive as a storage device for an internal print queue (prior art). As an improvement over the method of FIG. 1, this method implements multiple job pipelining in the device. In this method, the device has a hard-disk or RAM file system for implementing an internal print queue. An imaging device with an internal job queue capability has the ability to receive new jobs while processing an existing job. The imaging device sends a job acceptance notification back to the host, even though processing of the job(s) has not yet begun (e.g., RIP completion).

Advantageously, as the RIP process for a first job is completed, processing on the next job can begin immediately, without the delays associated with network transmissions and job completion notifications, as the job(s) are already stored in the imaging device. This method still suffers in that the method:

1. Requires sufficient available storage (HD or RAM) to hold subsequent job(s) while a current job is being processed.

2. Still has inter-RIP delays when winding up the processing of one job and starting the processing of another job (i.e., non-continuous job processing).

The Sharp AR-M450 is an example of an MFP with multiple job pipelining capability using a hard-drive as a storage device for an internal print queue.

It would be advantageous if an effective method existed for printing back-to-back single copy small print jobs, for example—jobs of a single page, as a continuous print job, or as a single RIP.

### SUMMARY OF THE INVENTION

The present invention describes an effective method for printing back-to-back single copy small print jobs, for example single-page jobs, as a continuous print job, such as a single RIP. This invention solves the problems associated with rated engine performance that occur when a printer receives a continuous stream of small print jobs, due to inter-job delays. This following is a list of 3 different aspects of the present invention:

1. Multiple print jobs can be merged into a single print job by a despooling component, such as a custom print processor or port monitor in MS-Windows, or a print filter in UNIX. The merged job can be a:
a. Compound Job˜each individual print job is concatenated, producing a single spool file with multiple RIPs.
b. Composite Job˜The instructions to end/start a RIP (e.g., UEL, Printer Reset, @PJL header sequence, and @PJL EOJ) between each individual print job are removed prior to concatenation, producing a single spool file with a single RIP.
c. Converted & Composite Job—The print job data is converted to another format, such as a TIFF image file.

The converted formatted files are then merged into a single RIP, such as a multi-page TIFF file. Note, this is not an exhaustive list of merged job examples.

2. Static controls for job joining. Pre-determined conditions are specified that control when jobs are merged during the de-spooling process, such as:
a. Print Data Format (e.g., Postscript, PCL, PCL XL)
b. Document Type (e.g., MS-Word, TIFF, HTML)
c. Threshold: print after joining a predetermined number of jobs or pages
d. Post-condition: begin print after waiting a predetermined number of seconds for the next job.

3. Dynamic controls for job joining. Adaptive run-time conditions may be selected. Examples of dynamic controls affecting when jobs are merged may include:
a. Pending Jobs: Merge when more jobs are pending. For example, if no jobs are pending, finish merge (if any) and print the merged job.
b. Performance Trade-Off: Analyze the overhead associated with merging jobs, such as job size/number of pages, vs. time gained by the merge. For example, if the gain is less than the overhead delay, then do not merge.
c. Intra-RIP conflict: Determine if job requirements between jobs, for example the number of copies, booklet printing, etc., create an output conflict or undesirable output if merged into a single RIP.
d. Intra-RIP conflict elimination: If possible, modify print data to eliminate intra-RIP conflicts. For example, the addition of a blank page to single page duplex job may resolve a conflict.

Accordingly, a method is provided for de-spooler job joining. The method comprises: despooling a plurality of print jobs at a client device; joining the plurality of print jobs into a single joined print job; and, rendering the joined print job as a single continuous print job. The de-spooler may be part of the imaging device printing the single continuous job, or part of the client device supplying the print jobs.

In one aspect, joining the plurality of print jobs into a single joined print job includes: concatenating the plurality of print jobs; creating a single spool file with multiple raster image processes (RIPs). Alternately, joining the plurality of print jobs into a single joined print job includes: generating a RIP for each print job, with RIP end/start instructions; removing the RIP end/start instructions; concatenating the plurality of RIPs; and, creating a single spool file with a single RIP. In another aspect, joining the plurality of print jobs includes: converting each print job into an image format file; and, merging the image format files into a single RIP.

The method may include the selection of static controls for choosing print job format, print job document type, threshold printing instructions, or printing delay instructions. Likewise, dynamic controls may be selected for analyzing dynamic conditions at run-time such as the number of pending print jobs, a merger performance analysis, inter-RIP conflicts analysis, or post-merger inter-RIP conflict resolution.

Additional details of the above-described method and a system for de-spooler job joining are provided below.

### BRIEF DESCRIPTION OF THE DRAWINGS

FIG. 1 is a schematic block diagram illustrating an MFP that implements a single job pipelining method (prior art).

FIG. 2 is a diagram showing a MFP with multiple job pipelining capability, using a hard-drive as a storage device for an internal print queue (prior art).

FIG. 3 is a schematic block diagram of a single job pipelining system, using a one-job look-ahead job cache.

FIG. 4 is a diagram illustrating a temporary storage method for merging print jobs.

FIG. 5 is a schematic block diagram of the present invention system for de-spooler job joining.

FIG. 6 is a schematic block diagram featuring an alternate aspect of the system of FIG. 5.

FIG. 7 is a block diagram example of the present invention enabled as a print subsystem.

FIG. 8 is a block diagram depicting the use of dynamic controls with the present invention.

FIG. 9 is a diagram depicting another aspect of the dynamic control process of FIG. 8.

FIGS. 10 and 11 are diagrams illustrating static controls associated with some aspects of the present invention.

FIG. 12 is a block diagram illustrating the intra-RIP conflict analysis process.

FIG. 13 is a flowchart illustrating the present invention method for de-spooler job joining.

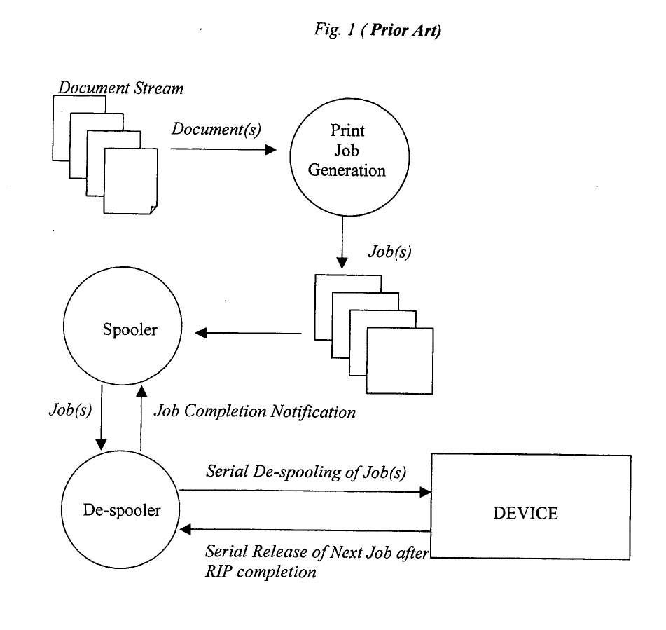

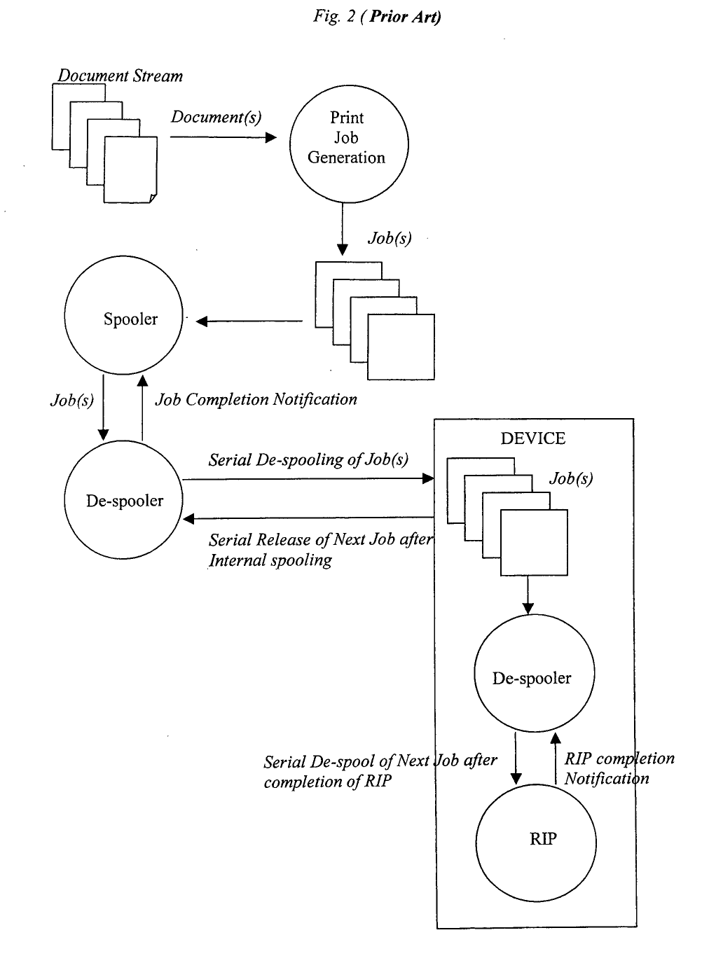

### DETAILED DESCRIPTION OF THE PREFERRED EMBODIMENTS

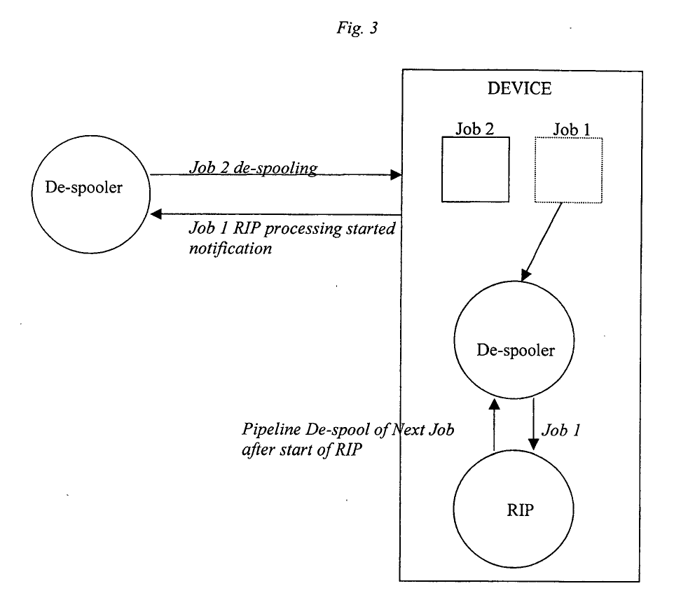

FIG. 3 is a schematic block diagram of a single job pipelining system, using a one-job look-ahead job cache. In this method, the device has a RAM, or disk buffer for forward storing a second print job. Upon receipt of the first print job, the printer starts processing the first print job. Once processing starts, the printer sends a premature RIP completion notification back to the host side, even though the RIP has not completed. This premature notification fakes the host-side spooler, causing it to immediately send (back-to-back without delay) the next job. While this method solves most of the inter-job network delay, it still suffers in that the method:

1. Provides only one job store forward, so there may still be some residual inter-job network delays in a continuous stream of small jobs.

2. Requires additional RAM.

3. Inter-RIP delays may still exist.

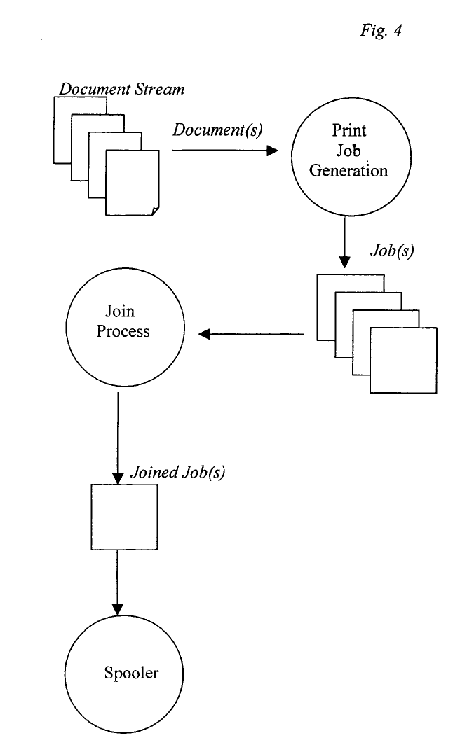

FIG. 4 is a diagram illustrating a temporary storage method for merging print jobs. In this method, MFP performance is improved by joining small single print jobs into a single job, or RIP on the host side. Each individual job, sometimes referred to as a job segment, is despooled to some temporary storage area after the job is created. For example, the job can be stored in a printer driver. When all the job segments have been produced, another process then merges the jobs into a single print job. One or more of the following may happen during the merge:

1. The job segments are merged in such a manner as to be printed as a single RIP (i.e., composite segments vs. batch job of compound segments). For example, a printer driver may build a composite print job (single RIP) from multiple (separate) invocations of the print command, such as building a composite print job from different documents.

2. The job segments are converted into another format.

For example, a Ghostscript program exists, available from the public domain that merges multiple postscript jobs into a single job, and converts the output format into a single multi-page TIFF file.

The above method still has the limitations that:

1. The merging of job segments is not independent of the print generation process. Thus, it cannot be applied to a set of print jobs from an arbitrary source.

2. The system is not automated and, therefore, must be manually executed.

3. There is no static process to determine if jobs should be merged on the basis of content or job intent.

4. There is no dynamic process to determine if jobs should be merged on the basis of print load or time-savings.

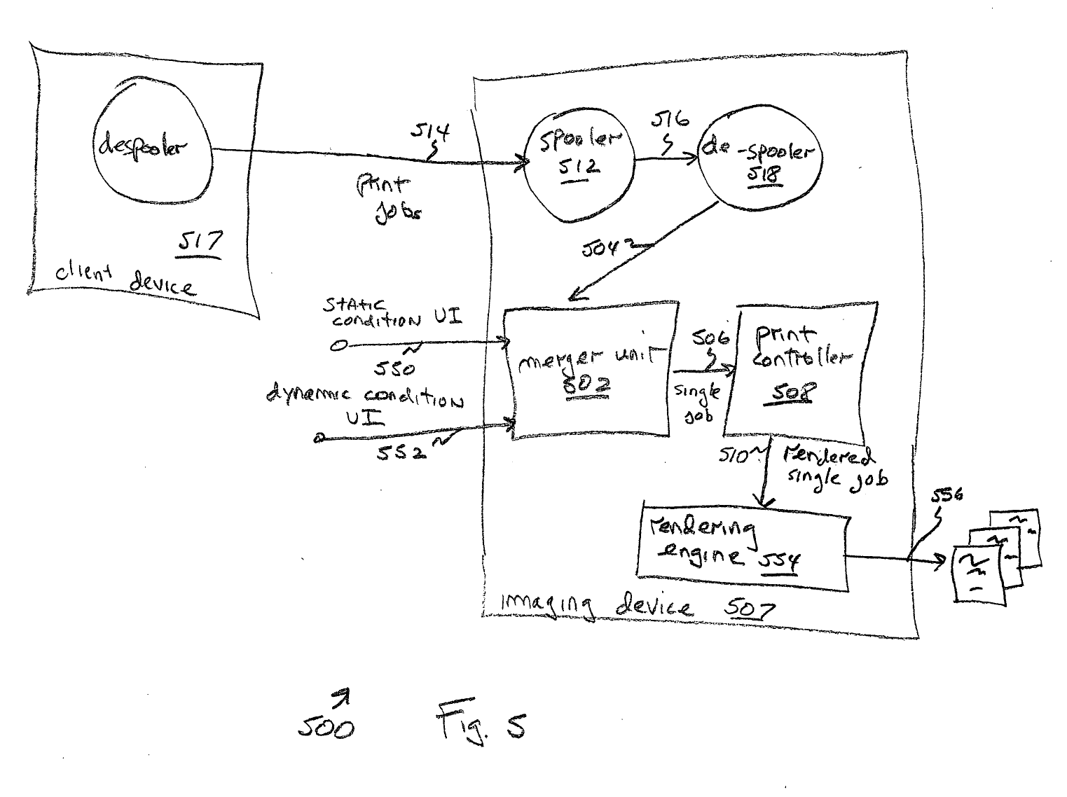

FIG. 5 is a schematic block diagram of the present invention system for de-spooler job joining. The system 500 comprises a merger unit 502 having an interface on line 504 to receive a plurality of despooled print jobs. The merger unit 502 joins the plurality of print jobs into a single joined print job supplied at an interface on line 506. An imaging device 507 print controller 508 has an interface on line 506 to accept the joined print job and an interface on line 510 to supply a document rendered as a single continuous print job.

In one aspect of the system 500, as shown in FIG. 5, the merger unit 502 is logically connected with the imaging device 507. As used herein, an imaging device may be a printer, scanner, fax, electronic whiteboard, tablet PC, or an MFP. In this aspect, the system further comprises an imaging device spooler 512 having a network-connected interface on line 514 to receive print jobs and an interface on line 516 to supply the received print jobs. As shown, the print jobs are being received from a single client device 517. However, it should be understood that the imaging device spooler 512 may be receiving jobs from multiple clients.

An imaging device de-spooler 518 has an interface on line 516 to receive the print jobs from the spooler 512 and an interface on line 504 to supply despooled print jobs to the merger unit 502. The spooler 512 and de-spooler 518 are conventional. However, in one aspect the merger unit 502 may be embedded with the de-spooler 518, or with other elements of a print driver subsystem.

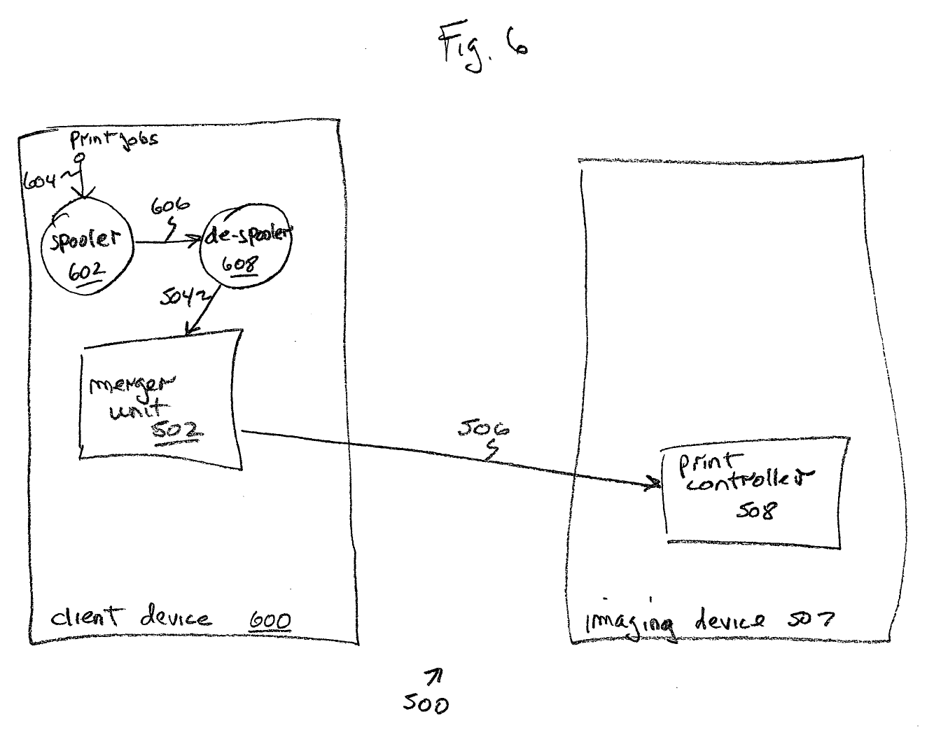

FIG. 6 is a schematic block diagram featuring an alternate aspect of the system 500 of FIG. 5. In this aspect the system 500 further comprises a client device 600, such as a server or personal computer, for example. The client device 600 includes a spooler 602 with an interface on line 604 to receive print jobs and an interface on line 606 to supply the received print jobs. A de-spooler 608 has an interface on line 606 to receive the print jobs from the spooler 602 and an interface on line 504 to supply despooled print jobs to the merger unit 502. In this aspect, the merger unit 504 is logically connected with the client device 600. The merger unit 504 has a network-connected interface on line 506 to supply the joined print job to the imaging device print controller. The imaging device print controller 508 has a network-connected interface on line 506 to receive the joined print job from the client device merger unit 502. Note, the network may represent a local connection, such as a USB or parallel port interface, or a larger network, such as a local area network (LAN) for example. Note, the client device 600 may be a server device that manages the despooling of imaging jobs from multiple other client devices (not shown) to the imaging device 507.

Referencing either FIG. 5 or 6, the merger unit 502 may join the plurality of print jobs into a single joined print job by concatenating the plurality of print jobs, and creating a single spool file with multiple rasterizations or raster image processes (RIPs). Alternately, the merger unit 502 may joins the plurality of print jobs by generating a RIP for each print job, with RIP end/start instructions. For example, RIP end/start instructions such as universal exit language (UEL), printer reset, @PJL header sequence, and/or @PJL EOJ may be used. Note, the above-mentioned examples are only a short list of instructions that might be used for this purpose. The merger unit 502 then removes the RIP end/start instructions, concatenates the plurality of RIPs, and creates a single spool file with a single RIP.

As yet another alternative, the merger unit 502 joins the plurality of print jobs by converting each print job into an image format file, and merging the image format files into a single RIP. For example, the print jobs can be converted into an image format file such as TIFF, JPEG, Windows bitmap, or PDF format files.

Referencing FIG. 5, in some aspects the merger unit 502 has a static condition user interface (UI) 550 for selecting static controls prior to joining the plurality of print jobs. The merger unit joins the plurality of print jobs into a single joined print job in response to the selected static controls. More specifically, static controls can be selected that include the single joined job print job format and/or print job document type. Threshold printing instructions may also be selected, where the threshold might be the number of jobs that must be accumulated before a merge is considered, the total page count of the accumulated jobs that triggers a merge, or the number of pages in a job before it is considered for merger. Another static control concerns printing delay instructions. For example, the amount of time spent waiting for newly accumulated (pending) jobs, before the currently accumulated jobs are rendered.

The merger unit 502 may also have a dynamic condition UI 552 for selecting dynamic controls. In this aspect the merger unit 502 analyzes dynamic conditions at run-time and joins the plurality of print jobs into a single joined print job in response to the dynamic conditions and the selected dynamic controls. For example, the merger unit 502 may accept a dynamic condition such as number of pending print jobs. For example, the control may be set to join jobs, if the number of accumulated jobs is 5, or more. Then, the merger unit analyzes the actual number of pending jobs and merges the jobs if the pending number exceeds the threshold of 5.

In other aspects, a merger performance analysis may be performed. That is, the control can be set to permit the merger unit to perform a trade-off analysis of whether the economy of joining of jobs exceeds the job joining overhead. In another aspect, inter-RIP conflicts are analyzed. An inter-RIP conflict occurs when the merging of two independent RIP segments into a single RIP does not produce the same output that occurs when the jobs are rendered independently. For example, an inter-RIP conflict might involve jobs that require a different size or type of paper media, or if a first job is copied a greater number of times than a subsequent job. In another aspect, a post-merger inter-RIP conflict resolution may be selected. For example, the merger unit may be enabled to add a blank sheet of paper between a first duplex print job ending on an odd-numbered page, and a subsequent duplex job. Note, although UI 550 and 552 have been associated with FIG. 5, they have equal applicability to the system of FIG. 6.

In some aspects, the system 500 further comprises an imaging device rendering engine 554 having an interface on line 510 to accept the rendered document from the print controller 508. The rendering engine 554 has interface on line 556 to supply documents in a format selected from the group including paper media, archive documents, or scanned image data. As shown, the rendering engine 554 is a print engine supplying paper media documents. In another aspect, the rendering engine may produce an electronic output that is then transmitted to another device for further rendering, such as in a fax transmission.

In another aspect, the merger unit 502 joins the plurality of print jobs into a single joined print job by converting each print job into a raster format file that is specific to the imaging device's rendering engine. The merger unit then merges the raster format files into a single RIP. Note, although rendering engine 554 has been shown as being associated with FIG. 5, it has equal applicability to the system of FIG. 6.

### Functional Description

Exemplary Environment—Job Joining during De-spooling

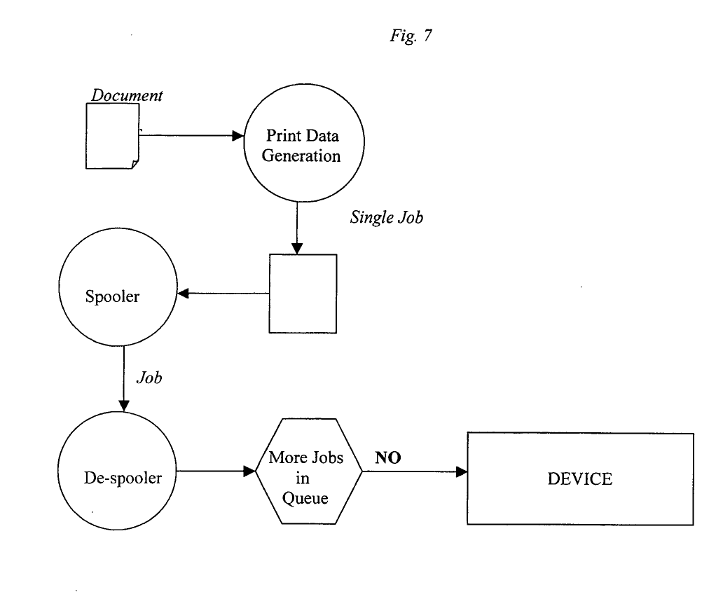

FIG. 7 is a block diagram example of the present invention enabled as a print subsystem. The exemplary print subsystem consists of a print generation method to generate two or more individual print jobs at the same printing device, a print spooler for scheduling the individual print jobs for de-spooling to the printing device, and a de-spooler for de-spooling the print jobs. The de-spooler has the capability of joining multiple individual print jobs into a single print job. The resulting joined file may be of a form including:

1. Concatenated Single Spool File—each individual job is concatenated together and sent as a single spool job, such as a batch or compound job. The jobs are then interpreted and RIP'd separately by the device, but are processed as a single contiguous task. That is, they are not interrupted by other jobs with equal or lower priority.

2. Single RIP Spool File—the instructions (UEL, @PJL, etc) that end and start the next RIP between jobs are removed when the individual jobs are joined. The jobs are then interpreted and RIP'd as a single RIP by the device.

3. Conversion—the print jobs are converted to document/image format for processing as a single RIP spool file. The print instructions are converted to a document/image format, such as PDF, JPEG, Windows Bitmap, or TIFF, as a multi-page document/image that can be directly processed by the device. Thus, the document/image data is processed as a single RIP.

Below is an example output of a PCL job produced by a Sharp AR-M277 PCL5e printer driver. The example demonstrates a RIP begin and RIP end command sequence, where <Esc> is the ANSI escape byte sequence:

| | | |
|---|---|---|
| <Esc>%-12345X@PJL | | |
| @PJL <command 1> | | |
| . . . | {close oversize brace} | RIP begin command sequence |
| @PJL ENTER LANGUAGE=PCL | | |
| <Esc>E | | |

| | |
|---|---|
| {close oversize brace} | Print Data |

| | | |
|---|---|---|
| <Esc>%-12345X | | |
| @PJL EOJ NAME=″<job name>″ | {close oversize brace} | RIP end command sequence |
| <Esc>%-1 2345X | | |

Job Joining—Dynamic Criteria

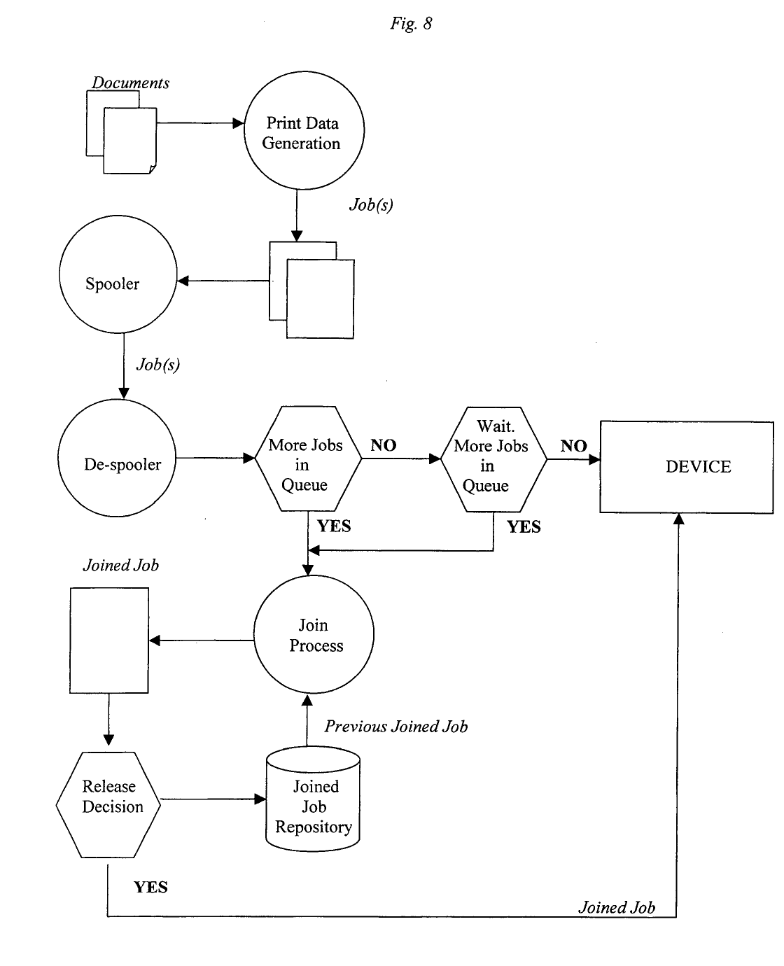

FIG. 8 is a block diagram depicting the use of dynamic controls with the present invention. In this aspect, the de-spooler uses dynamic controls for deciding when a job is to be joined. One example of a dynamic control is the consideration of the job load pending to the device. For example, the method could consider whether other jobs are immediately pending for de-spooling to the device. If the current job is the only job, there are no more jobs in the queue and no previous pending joined job, then the job is immediately de-spooled to the device. If there are more pending jobs, then the current print job is merged with the subsequent pending job(s). In an alternate embodiment, the process may wait for some specified period (i.e., timeout) for a pending job to appear. After the specified period has elapsed without a pending job, the current job is then released for printing.

Another method considers the size of the job, such as in bytes or pages. The method can use the job size information to estimate the time to join the job vs. the estimated inter-RIP delay. If the estimated job joining time is greater than the estimated inter-RIP delay, then there would is no advantage in joining the jobs, and the job is immediately de-spooled.

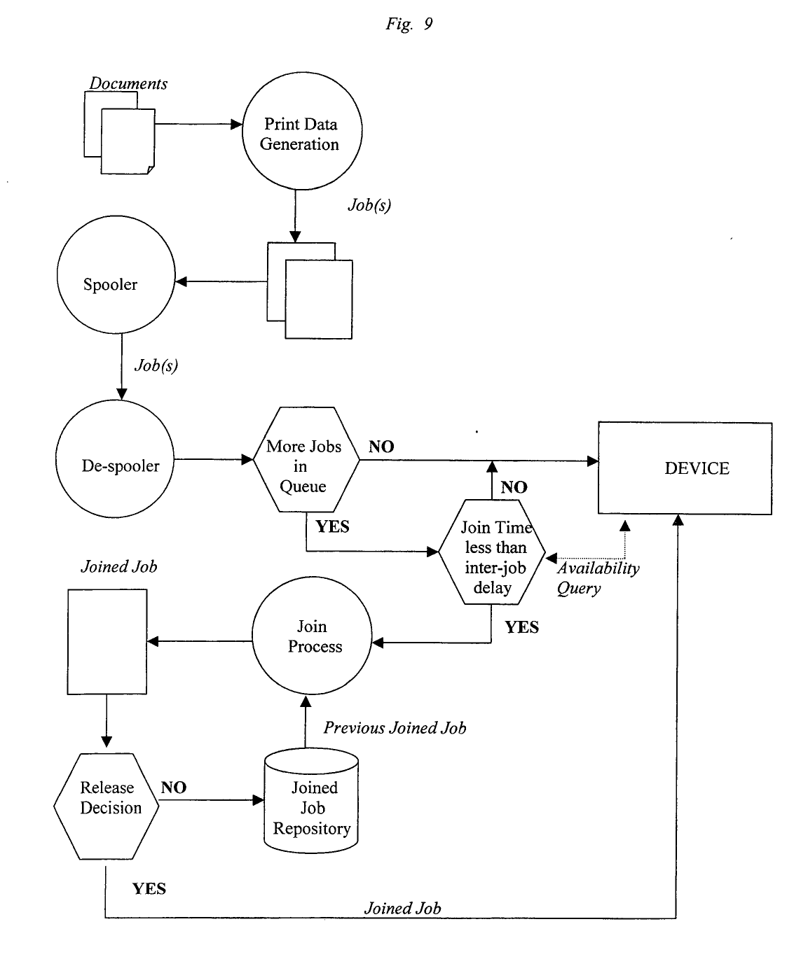

FIG. 9 is a diagram depicting another aspect of the dynamic control process of FIG. 8. In this aspect, the current load on the device is considered. If the device is currently busy and, thus cannot process the next job immediately, then the method join jobs, as long as the estimated job joining time is less than the estimated device availability time. In some aspects, if a device is busy, the job joining time is always assumed to be completed before the device is available. In other aspects, the method obtains a job completion estimate from the device using a device management protocol, such as Simple Management Network Protocol (SNMP).

Job Joining—Static Criteria

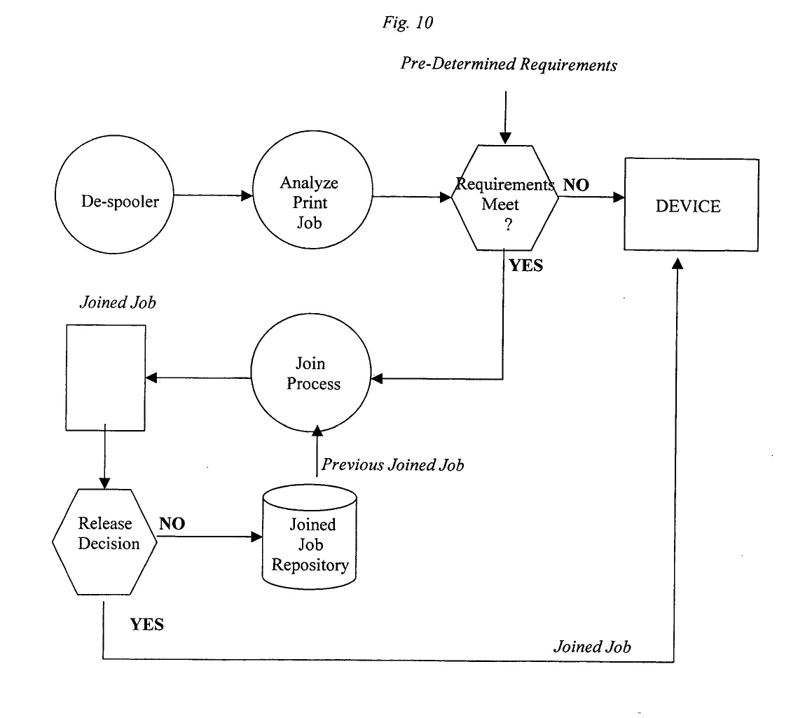

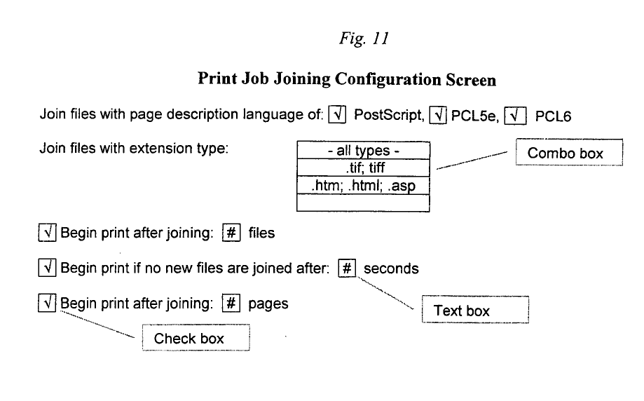

FIGS. 10 and 11 are diagrams illustrating static controls associated with some aspects of the present invention. In this aspect, the job joining and release methods may use pre-determined criteria. The user, or other process, specifies one or more requirements for individual jobs to be joined into a single job. When a print job becomes a candidate for job joining, the attributes/characteristics of the print job are then compared to the pre-specified requirements. If the print job does not meet the pre-specified requirements, the print job is not joined and is de-spooled to the printing device as an individual print job. The pre-specified requirement matching may be combined with other criteria, such as the aforementioned dynamic criteria, in deciding whether a print job is to be joined with other print job(s). Examples of pre-specified criteria include:

1. Document/Image format, for example TIFF, PDF, MS-Word, or HTML. The print job is analyzed to determine the document/image format of the original document/image data. The print data may be examined for a command that contains information about the original document, for example, @PJL JOB NAME=“<application><document-name>”.

2. Print Data Type. The print job is analyzed to determine the format of the print data. For example, the print data may be examined for an explicit language switch command, for example @PJL ENTER LANGUAGE=<language>, or an implicit switch by looking for a language specific signature sequence, for example %!PS for Adobe Postscript®.

3. Number of Pages. The print job is analyzed to determine the number of pages in the job. For example, the spooler may be queried, for example MS-Windows Spooler API GetJob( ), to determine if the number of pages is specified as part of the job submission. The print data can be analyzed for the number of page separation commands, for example form feed, change media source, etc. The print data can be analyzed for metadata that is indicative of the number of pages, for example the number of IFDs in a TIFF formatted bitmap.

Other pre-determined criteria may be used as part of the decision to release an existing joined job, including:

1. The total number of pages in the joined job.

2. The total number of jobs in the joined job.

3. The amount of elapsed time while waiting for another job to join.

Intra-RIP Conflict Handling when Joining into a Single Rip

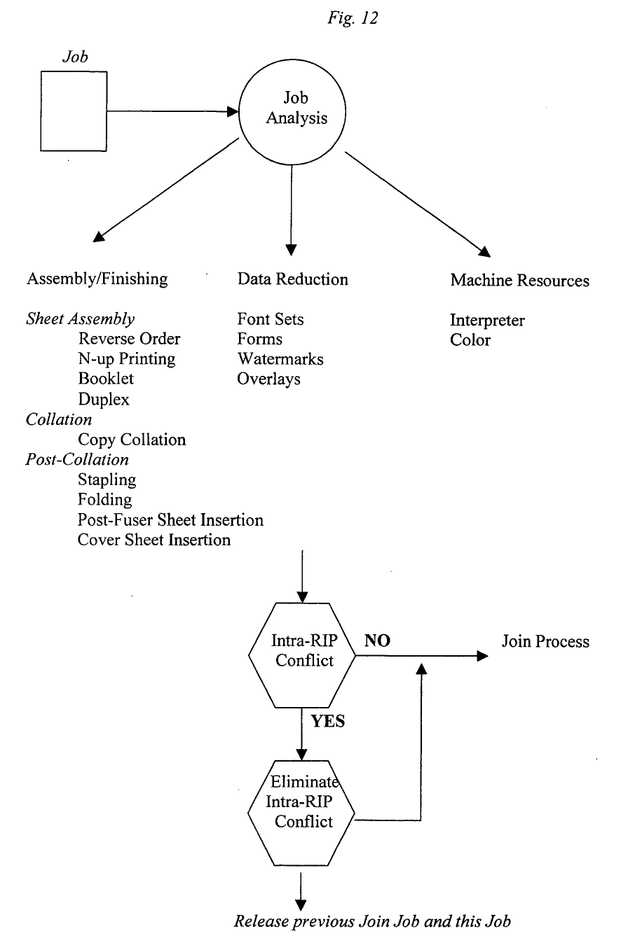

FIG. 12 is a block diagram illustrating the intra-RIP conflict analysis process. In this aspect, the individual print jobs may be further analyzed for intra-RIP conflicts when they are joined into a single RIP job. Intra-RIP conflicts may be caused by print settings that are job-wide and can only have a single value across the entire RIP. For example, when a first and second job both have a setting for collated copies, but a different copy count. The desired result would be that the first job outputs N collated copies, followed by the second job outputted as M collated copies. But if the jobs are merged into a single RIP, then the output would be a combined first and second job outputted as either N or M collated copies, but not both.

Other print settings that can cause intra-RIP conflicts include:

1. Settings that place more than one image on a sheet or sheet face, for example duplex, booklet, or N-up.

2. Settings that re-order pages, for example reverse order or booklet.

3. Settings that apply binding operations, for example folding or stapling.

4. Settings that add sheets after the fuser, for example front and back cover insertions.

Another example of an intra-RIP conflict is a print data language change, such as going from Postscript to PCL. Jobs with different print data languages cannot be merged into a single RIP since the change, from one print data language to another, typically (but not always) results in an implicit end of RIP by the device. Some examples of print data language changes that do not result in an implicit end of RIP include: PJL to a page description language; and, PCL to HP/GL2.

In one aspect, if an intra-RIP conflict is detected, the print job is not joined. Instead, the print job is printed as an individual job. If there is an existing joined job pending, the joined job may also be printed, or it may continue to wait for other release conditions.

In another embodiment, an attempt is made to resolve the intra-RIP conflicts, if possible. The resolution may result in the modification of the print data in either the current print job, or the previous joined job. For example, if a first and second individual job both have duplex setting, but the first job ends in an odd number of pages, a command may be inserted to cause a blank page to be added to the first job. In another example, if a first and second individual jobs have different print data languages, one may be converted to the print data language of the other, or both converted to a third print data language.

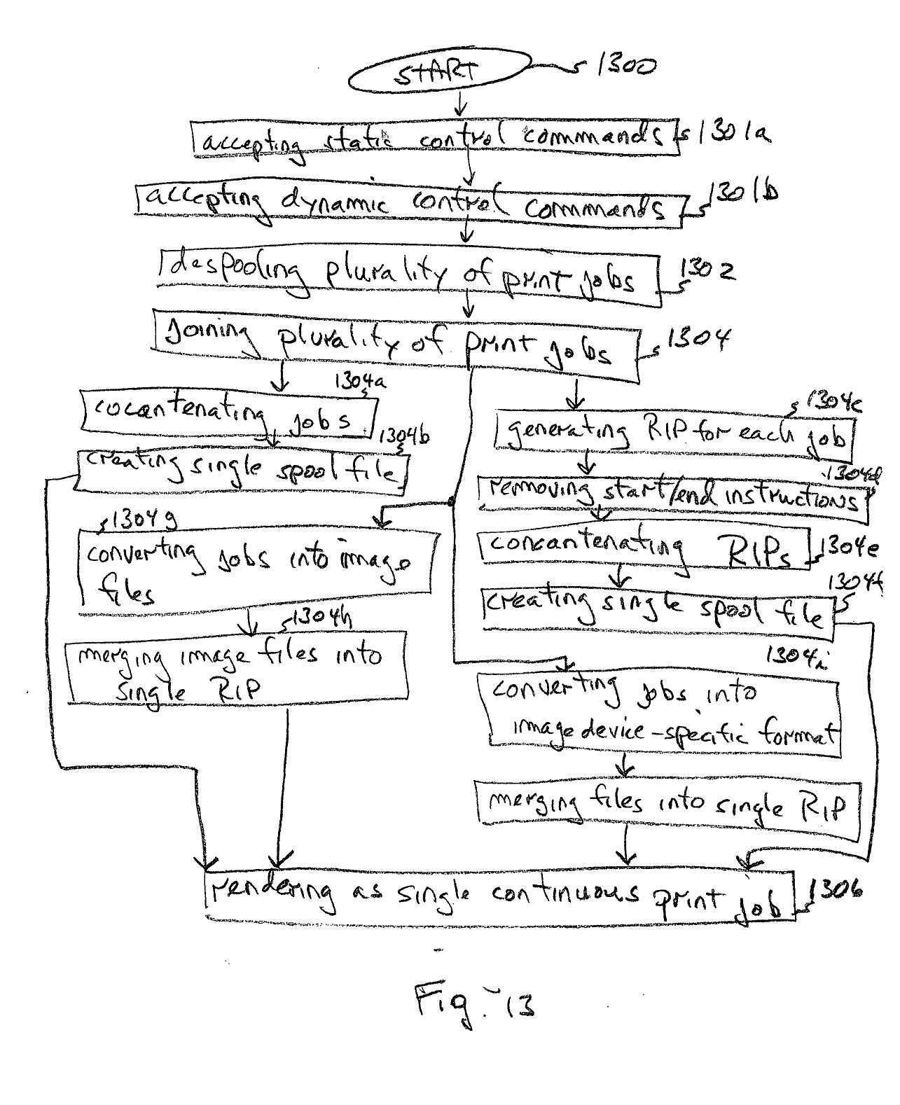

FIG. 13 is a flowchart illustrating the present invention method for de-spooler job joining. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 1300.

Step 1302 despools a plurality of print jobs at a client device. Step 1304 joins the plurality of print jobs into a single joined print job. Step 1306 renders the joined print job as a single continuous print job. In one aspect, Step 1303a (not shown) receives the plurality of print jobs at an imaging device and Step 1304 joins the plurality of print jobs at the imaging device. In another aspect, Step 1304 joins the plurality of print jobs at the client device and a further step, Step 1308 (not shown) sends the joined print job to an imaging device.

Joining the plurality of print jobs into a single joined print job in Step 1304 may include the following substeps. Step 1304a concatenates the plurality of print jobs. Step 1304b creates a single spool file with multiple RIPs. Alternately, Step 1304c generates a RIP for each print job, with RIP end/start instructions. For example, Step 1304c may generate instructions such as UEL, printer reset, @PJL header sequence, or @PJL EOJ instructions. Step 1304d removes the RIP end/start instructions. Step 1304e concatenates the plurality of RIPs. Step 1304f creates a single spool file with a single RIP.

In another aspect, Step 1304g converts each print job into an image format file, such as a TIFF, JPEG, Windows bitmap, or PDF format file. Step 1304h merges the image format files into a single RIP. In yet another aspect, Step 1304i converts each print job into a raster format file specific to an imaging device's rendering engine. Step 1304j merges the raster format files into a single RIP.

In other aspects, a further step, Step 1301a, accepts static control selection commands prior to joining the plurality of print jobs. Then, Step 1304 joins the jobs in response to the selected static controls. For example, the selected static controls may include a selected print job format, print job document type, threshold printing instructions, or printing delay instructions.

In a different aspect, Step 1301b accepts dynamic control selection commands and Step 1303b (not shown) analyzes dynamic conditions at run-time. Then, Step 1304 joins the jobs in response to the dynamic conditions and the selected dynamic controls. For example, in Step 1301b, dynamic condition controls may be selected from the group including the number of pending print jobs, a merger performance analysis, inter-RIP conflicts analysis, and post-merger inter-RIP conflict resolution.

A system and method have been presented for joining a plurality of print jobs into a single, continuous job rendering, to take advantage of an imaging device's print engine capabilities. Although the rendering may result in a print job product, other imaging device rendering options include fax, scan, document management, archive/retrieval, manipulation, and transfer operations.

Although the invention has generally been explained in the context of a Microsoft Windows® operating system, the invention can also be practiced with subsystems of an Apple MacIntosh Operating System, Linux Operating System, System V Unix Operating Systems, BSD Unix Operating Systems, OSF Unix Operating Systems, Sun Solaris Operating Systems, HP/UX Operating Systems, or IBM Mainframe MVS and AS/400 Operating System, to name a limited list of other possibilities. Other variations and embodiments of the invention will occur to those skilled in the art.

1. A method for de-spooler job joining, the method comprising:
at a client device, despooling a plurality of print jobs;
joining the plurality of print jobs into a single joined print job; and,
rendering the joined print job as a single continuous print job.

2. The method of claim 1 further comprising:
receiving the plurality of print jobs at an imaging device; and,
wherein joining the plurality of print jobs into a single joined print job includes joining the plurality of print jobs at the imaging device.

3. The method of claim 1 wherein joining the plurality of print jobs into a single joined print job includes joining the plurality of print jobs at the client device; and,
the method further comprising:
sending the joined print job to an imaging device.

4. The method of claim 1 wherein joining the plurality of print jobs into a single joined print job includes:
concatenating the plurality of print jobs; and,
creating a single spool file with multiple raster image processes (RIPs).

5. The method of claim 1 wherein joining the plurality of print jobs into a single joined print job includes:
generating a RIP for each print job, with RIP end/start instructions;
removing the RIP end/start instructions;
concatenating the plurality of RIPs; and,
creating a single spool file with a single RIP.

6. The method of claim 5 wherein generating a RIP for each print job, with RIP end/start instructions, includes generating instructions selected from the group including universal exit language (UEL), printer reset, @PJL header sequence, and @PJL EOJ.

7. The method of claim 1 wherein joining the plurality of print jobs into a single joined print job includes:
converting each print job into an image format file; and,
merging the image format files into a single RIP.

8. The method of claim 7 wherein converting each print job into an image format file includes converting each print job into an image format file selected from the group including TIFF, JPEG, Windows bitmap, and PDF format files.

9. The method of claim 1 further comprising:
prior to joining the plurality of print jobs, accepts static control selection commands; and,
wherein joining the plurality of print jobs into a single joined print job includes joining the jobs in response to the selected static controls.

10. The method of claim 9 wherein accepting static control selection commands includes selecting a control from the group including print job format, print job document type, threshold printing instructions, and printing delay instructions.

11. The method of claim 1 further comprising:
accepting dynamic control selection commands;
analyzing dynamic conditions at run-time; and,
wherein joining the plurality of print jobs into a single joined print job includes joining the jobs in response to the dynamic conditions and the selected dynamic controls.

12. The method of claim 11 wherein accepting dynamic control selection commands includes selecting controls from the group including the number of pending print jobs, a merger performance analysis, inter-RIP conflicts analysis, and post-merger inter-RIP conflict resolution.

13. The method of claim 1 wherein joining the plurality of print jobs into a single joined print job includes:
converting each print job into a raster format file specific to an imaging device's rendering engine; and,
merging the raster format files into a single RIP.

14. A system for de-spooler job joining, the system comprising:
a merger unit having an interface to receive a plurality of despooled print jobs, the merger unit joining the plurality of print jobs into a single joined print job supplied at an interface; and,
an imaging device print controller having an interface to accept the joined print job and an interface to supply a document rendered as a single continuous print job.

15. The system of claim 14 wherein the merger unit is logically connected with the imaging device; and,
the system further comprising:
an imaging device spooler having a network-connected interface to receive print jobs and an interface to supply the received print jobs; and,
an imaging device de-spooler having an interface to receive the print jobs from the spooler and an interface to supply despooled print jobs to the merger unit.

16. The system of claim 14 further comprising:
a client device including:
a spooler with an interface to receive print jobs and an interface to supply the received print jobs;
a de-spooler having an interface to receive the print jobs from the spooler and an interface to supply despooled print jobs to the merger unit;
wherein the merger unit is logically connected with the client device, the merger unit having a network-connected interface to supply the joined print job to the imaging device print controller; and,
wherein the imaging device print controller has a network-connected interface to receive the joined print job from the client device merger unit.

17. The system of claim 14 wherein the merger unit joins the plurality of print jobs into a single joined print job by concatenating the plurality of print jobs, and creating a single spool file with multiple raster image processes (RIPs).

18. The system of claim 14 wherein the merger unit joins the plurality of print jobs into a single joined print job by: generating a RIP for each print job, with RIP end/start instructions; removing the RIP end/start instructions; concatenating the plurality of RIPs; and, creating a single spool file with a single RIP.

19. The system of claim 18 wherein the merger unit generates RIP end/start instructions selected from the group including universal exit language (UEL), printer reset, @PJL header sequence, and @PJL EOJ.

20. The system of claim 14 wherein the merger unit joins the plurality of print jobs into a single joined print job by converting each print job into an image format file, and merging the image format files into a single RIP.

21. The system of claim 20 wherein the merger unit converts each print job into an image format file selected from the group including TIFF, JPEG, Windows bitmap, and PDF format files.

22. The system of claim 14 wherein the merger unit has a static condition user interface (UI) for selecting static controls prior to joining the plurality of print jobs, the merger unit joining the plurality of print jobs into a single joined print job in response to the selected static controls.

23. The system of claim 22 wherein the merger unit is responsive to static controls selected from the group including print job format, print job document type, threshold printing instructions, and printing delay instructions.

24. The system of claim 14 wherein the merger unit has a dynamic condition UI for selecting dynamic controls, the merger unit analyzing dynamic conditions at run-time and joining the plurality of print jobs into a single joined print job in response to the dynamic conditions and the selected dynamic controls.

25. The system of claim 24 wherein the merger unit accepts dynamic controls selected from the group including the number of pending print jobs, a merger performance analysis, inter-RIP conflicts analysis, and post-merger inter-RIP conflict resolution.

26. The system of claim 14 further comprising:
an imaging device rendering engine having an interface to accept the rendered document from the print controller and an interface to supply documents in a format selected from the group including paper media, archive documents, and scanned image data.

27. The system of claim 26 wherein the merger unit joins the plurality of print jobs into a single joined print job by converting each print job into a raster format file which is specific to the imaging device's rendering engine, and merging the raster format files into a single RIP.
